(19) United States
(12) Patent Application Publication
(10) Pub. No.: US 2023/0292735 A1
(43) Pub. Date: Sep. 21, 2023

(54) Method of Applying Powder to Kill Insects

(71) Applicants: Thomas Michael Norton, Gladstone, OR (US); Cynthia Carol Norton, Gladstone, OR (US)

(72) Inventors: Thomas Michael Norton, Gladstone, OR (US); Cynthia Carol Norton, Gladstone, OR (US)

(21) Appl. No.: 17/700,202

(22) Filed: Mar. 21, 2022

(51) Int. Cl. A01M 9/00; A01N 61/00; A01N 59/14; A01N 47/22; A01N 53/00; A01N 25/12; A01P 7/04; B05B 1/10; B05B 1/06; B05B 1/14; B05B 1/04

(52) U.S. Cl. CPC A01M 9/0076; A01N 61/00; A01N 59/14; A01N 47/22; A01N 53/00; A01N 25/12; A01P 7/04; B05B 1/10; B05B 1/06; B05B 1/14; B05B 1/042

(57) ABSTRACT

A method of improving the performance of a powder dusting tip delivering powdered diatomaceous earth powder minimizing clogging in powder bulb duster tips through the use of tips with a more free flowing configuration and different spray patterns than the standard tip assembly and a flexible one piece powder dusting tube, which is attached to the tips which connects to reservoir of powder type insect repellents such as diatomaceous earth pesticides, boric acid pesticides, sevin based insecticides, deltamethrin based insecticides, and permethrin based insecticides as well as other powdered insecticides through threaded connections, made from flexible rubber tubing supported by memory wire that allows the powder duster tip to be positioned for hard to reach areas.

### FIELD OF THE INVENTION

The deployment of powder type insect repellents such as diatomaceous earth pesticides, boric acid pesticides, sevin based insecticides, deltamethrin based insecticides, and permethrin based insecticides as well as other powdered insecticides to prevent insect infestation in fruit and vegetable gardens or orchards, as well as around and inside buildings, through the use of novel, high flow powder duster tips and a flexible tube that connects to the storage reservoir.

### BACKGROUND

A wide variety of powders are used for pest controls in gardens and orchards when organic gardening is desired, as no insecticides are used on the vegetables or fruit. Diatomaceous earth powder works because it is a desiccant that causes insects to dry out and die by absorbing the oils and fats from the cuticle of the insect's exoskeleton, without these oils and fats the insect cannot retain water and dies of dehydration. This is a safer way to kill insects than the use of insecticides which use chemicals.

All building owners and renters have a desire to prevent insects from infesting their building. This requires killing insects inside a structure and also putting up a protective layer of powder around the building. Increasingly diatomaceous earth powder is used to kill insects, rather than insecticides which are made with chemicals, as they are safer. Conventionally, if a tool is used rather than spreading by hand, this is done by spreading a insecticide powder with a powder bulb duster which consists of a silicone bulb reservoir for the powder, which is squeezed to send the powder through a lance, wand or spray apparatus tube to a tip that directs the powder to the targeted area.

Conventional bulb dusters tips frequently get clogged as they have orifices that are too small and that also send out a small spray pattern. The objective of this application is to use a method using new larger tips, with varying spray patterns to prevent clogging. The variety of tips in this application is due to the varying desired spray pattern, as well as the variety of composition of the diatomaceous earth materials, with some being powders while others are granular.

### PRIOR ART

Bulb based delivery systems, delivering powder or sprays for a wide variety of applications go back almost, if not more than 100 years. One of the early patents was U.S. Pat. No. 1,628,843, Horton form May of 1927. There hasn't been much patent activity in this product area since then, but the market is full of a variety of products delivering powder or sprays.

Many of these devices have tips, which primarily take the flow from the lance (the tube coming from the reservoir bulb that stores the product and also acts, when squeezed as a propellant) and direct the flow into a smaller orifice to increase the velocity of the spray or powder out from the lance, or a tube connected to the bulb revoir.

There are dozens of these products on the market. The main issue with the tips that increase velocity is that they are small and easily become clogged, especially when a powder such as diatomaceous earth powder is used. The other issue is that in some applications, where diatomaceous earth powder is applied to fruits and vegetables, there is no need to have high velocity output from the tip as the tip can be placed close to the targeted area. The ability to target areas without a high velocity tip can be improved by having the lance, or wand which is also called a tube from the reservoir source to the tip being a flexible tube that be angled into a desired configuration.

### SUMMARY OF THE INVENTION

The present invention goes from a reservoir for insecticide powder, and a propellant system for the powder and applies a variety of distribution patterns of the powder, with the use of wider mouth openings in the tips that are currently available, those tips also able to distribute the powder with minimal clogging. The reservoir and propellant systems are similar to other systems. This invention is different in that it moves away from restricting the size of the tip orifice to improve a flow rate, to doing the opposite, enlarging the tip orifice from the orifice size of the lance, or tube from the reservoir and then adding a flexible tube, which contains memory wire, to assist in reaching areas where normal spread patterns would miss. The enlarged orifices come in four patterns. One is a Cloud Tip pattern (FIG. 9) which has a spray pattern that directs the spray vertical and horizontal, which has a spray pattern that works for orchards and larger vegetables. One is a Fan Tip, (FIG. 9) which allows a user to walk down a row with vegetable plants and simultaneously spray to the right and left/either side. One is a non-tapered Stream Tip (FIG. 5) pattern which is designed to handle very large granular insecticide powder. One is a tapered Stream Tip (FIG. 1) which is designed to handle the granular forms of powder that severely clogs most traditional tips. The key to this method is that the tips are larger than the lances, wands or spraying apparatus coming from the reservoir of insecticide powders that feeds the spraying apparatus.

### OBJECT OF THE INVENTION

The object of the invention is to utilize a new method for dispersing diatomaceous earth powder with a minimum amount of clogging.

### BRIEF DESCRIPTION OF DRAWINGS

FIG. 1 shows the tapered stream tip in a vertical position from the side.

FIG. 2 shows the cloud tip in a vertical position from the side.

FIG. 3 shows the cloud tip 7 from the top.

FIG. 4 shows how the flexible rubber tube connects to a base within the reservoir container.

FIG. 5 shows a non-tapered stream tip in a vertical position from the side.

FIG. 6 shows the top of the fan tip.

FIG. 7 shows the flexible tube portion of the tip, without the flexible tube portion being connected to the tip,

FIG. 8 shows the spray pattern of the fan tip.

FIG. 9 shows the spray pattern of the cloud tip.

FIG. 10 shows the spray pattern of the stream tips.

### PART NUMBER DESCRIPTION

1. Stream tip (tapered)
2. Top of stream tip
3. End of flexible tube whose connection is molded into the base of each the tip
4. Female thread from lance, wand or spraying apparatus which is attached to the reservoir of the insecticide powder being spread, typically diatomaceous earth powder.
5. Cross section of the top of cloud tip.
6. Support pillar for cloud tip
7. Cloud tip
8. Base, located in any reservoir holding material being spread, with a male thread to accept the female thread at the end of the flexible tube which is molded into the tip, a one piece molding.
9. Fan tip
10. Center section of fan tip
11. Flow through section of fan tip.
12. Internal flex wire that is internal to the rubber tube that connects the tip to the source of insecticide powder.
13. Flexible rubber tube that connects tip to source of insecticide powder
14. Male thread that extends from the base of the source of insecticide powder and holds the female thread of the rubber tube that extends from the tip.
15. An optional larger stream tip for instances where the material being dispensed has large granular pieces.
16. Spread pattern from the cloud tip
17. Spread pattern from the fan tip
18. Spread pattern from the stream tip.

### DETAILED DESCRIPTION

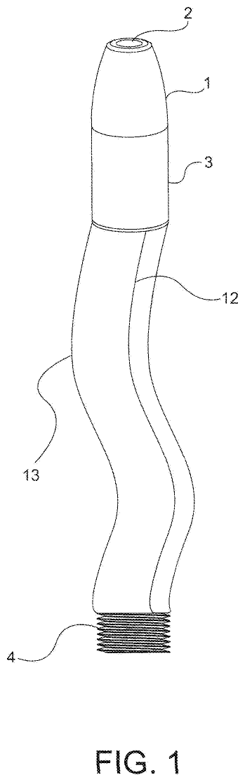

FIG. 1 shows the tapered stream tip 2, with the top section 1 being a part of the one piece molded tip 2 and flexible rubber tube 13, with an internal flex wire 12 that is attached to the tip is a section, 3, with the end of the flexible rubber tube 13, away from the tip, having a female thread 4 that attaches to the container source and/or spraying apparatus with the insecticide powder being sprayed.

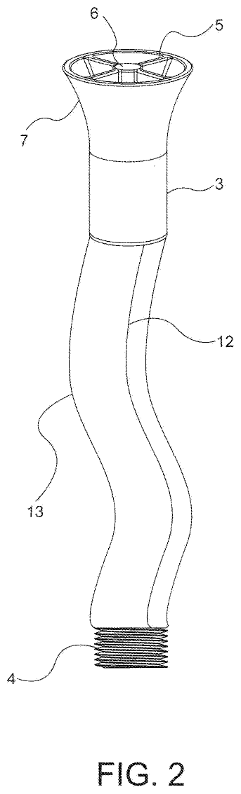

FIG. 2 shows the cloud tip 7, which has a center support 6, and that attaches to the tip 7 through cross section pieces 5. The cloud tip 7, being the top section 1 being a part of the one piece molded cloud tip 7 and flexible rubber tube 13, with an internal flex wire 12 that is attached to the tip with a section, 3, with the end of the flexible rubber tube 13, away from the tip, having a female thread 4 that attaches to the container source and or spraying apparatus of the insecticide powder being sprayed.

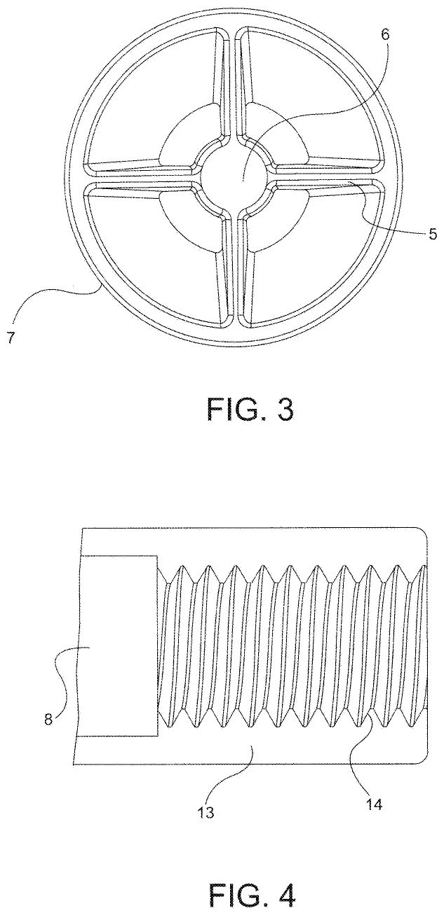

FIG. 3 shows the cloud tip 7 from the top, showing the pillar in the middle 6 and the cross section pieces 5

FIG. 4 shows how the flexible rubber tube connects to a base within the reservoir container 8 and/or spraying apparatus which has a male thread 14 that connects to the female thread of the flexible rubber connecting tube 13 with the flexible rubber tube's internal flex wire 12.

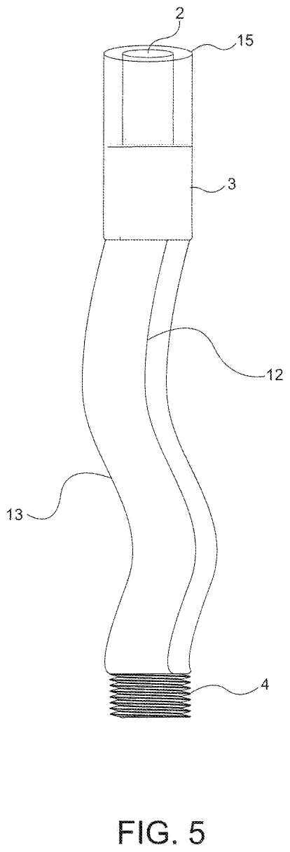

FIG. 5 shows a non-tapered stream tip 15 with the top section 15 being a part of the one piece molded tip 2 and flexible tube 13, with an internal flex wire 12 that is attached to the tip is a section, 3, with the end of the flexible tube 12, away from the tip, having a female thread 4 that attaches to the container source and/or spraying apparatus of the insecticide powder being sprayed.

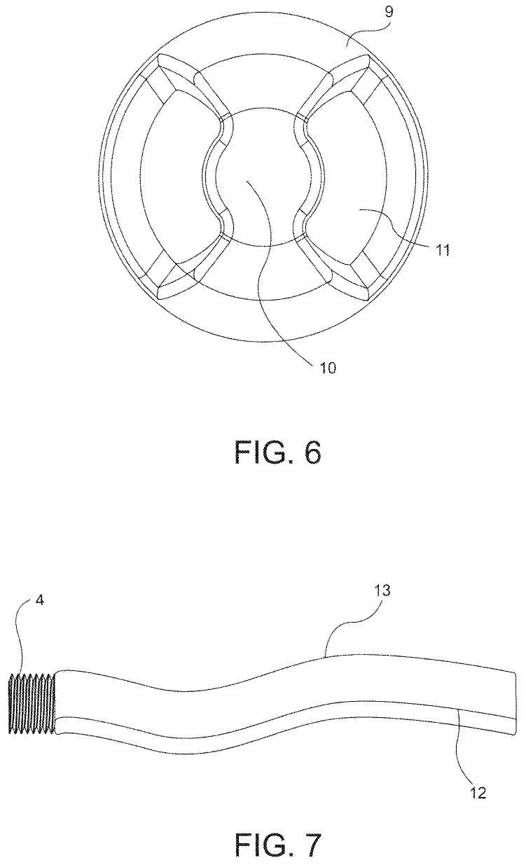

FIG. 6 shows the top of the fan tip 9, which has a center section 10, and two openings 11 to spread the material both left and right. After the fan tip it is constructed similarly to the tapered stream tip 1 and cloud tip 7, with one piece construction to a flexible rubber tube 13 with an internal flex wire 12, with the end of the tube away from the tip having a female threaded end 4.

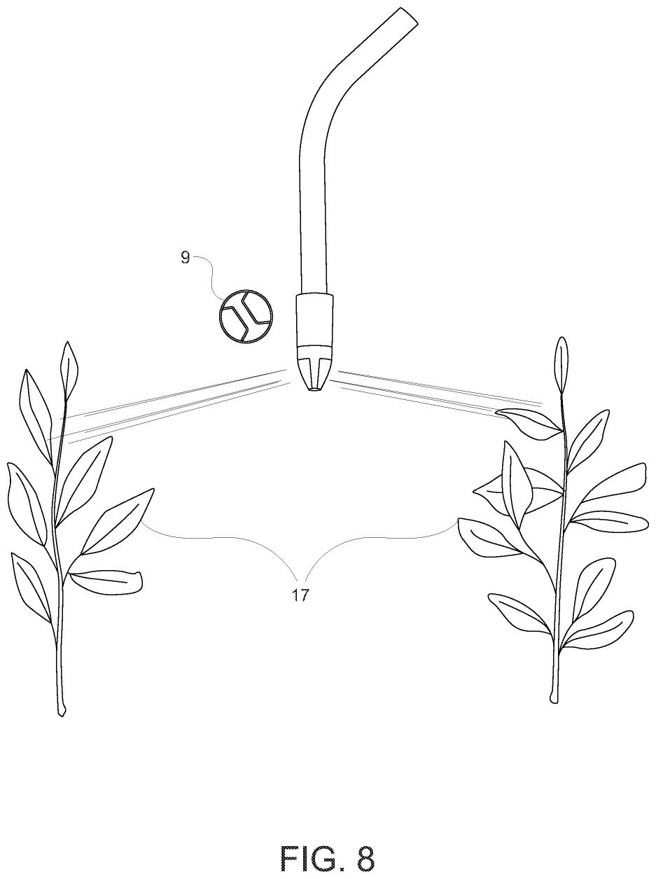

FIG. 7 shows the flexible tube portion of the tip, without being connected to the tip, with the threaded end 4, the flexible rubber tube 13, and the internal flex wire 12.

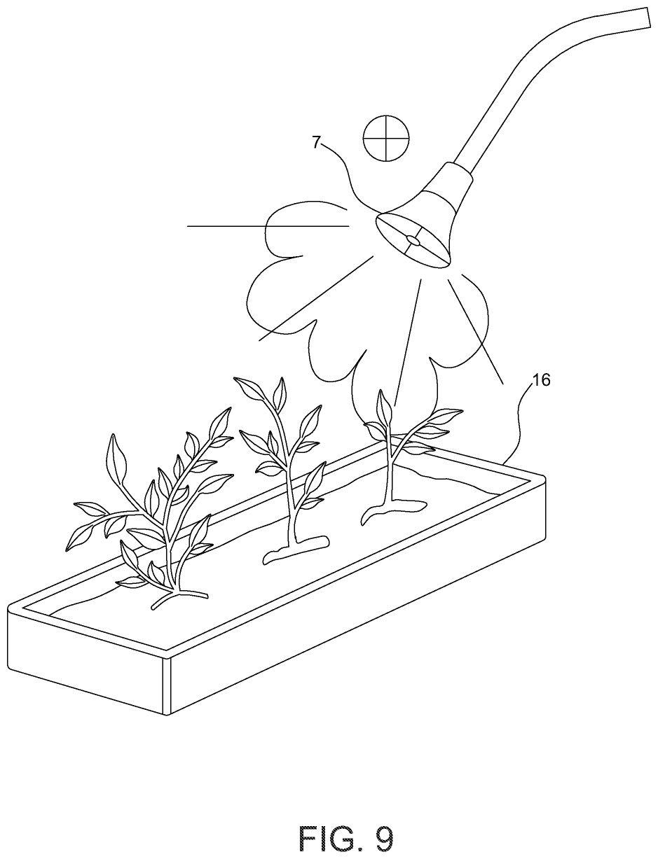

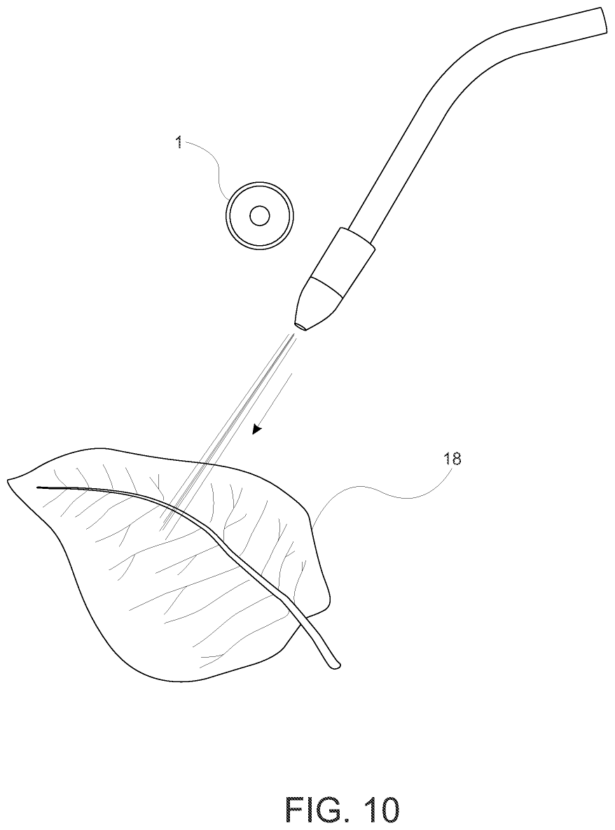

FIG. 8, FIG. 9 and FIG. 10 show the spray pattern of the fan, cloud and stream tips.

I claim:

1. A method for spraying insecticide powder, such as such as diatomaceous earth pesticides, boric acid pesticides, sevin based insecticides, deltamethrin based insecticides, and permethrin based insecticides as well as other powdered insecticides comprising:
a first step of preparing a plurality of different kinds of tips that all have wide openings to direct a spray over a large area;
a second step of molding the tips in a one piece configuration with a flexible rubber tube(ing), with an internal flex wire being attached to the flexible rubber tube(ing);
a third step of molding a threaded female end, on the end of the flexible rubber tube(ing) away from the tip, in the one piece configuration;
a fourth step of attaching the threaded female end to a male threaded end that resides in the base of a reservoir and/or spraying apparatus containing the insecticide powder being spread;
the plurality of tips comprising;
a tapered stream tip
a non-tapered stream tip;
a fan tip;
a cloud tip.

2. The method of claim 1 where the only tip is a tapered stream tip.

3. The method of claim 1 where the only tip is a non-tapered stream tip.

4. The method of claim 1 where the only tip is a fan tip.

5. The method of claim 1 where the only tip is a cloud tip.

6. The method of claim 1 where only two of the four tips are used.

7. The method of claim 1 where only three of the four tips are used.
